(19) United States
(12) Patent Application Publication
(10) Pub. No.: US 2009/0006233 A1
(43) Pub. Date: Jan. 1, 2009

(54) Electronic Fund Transfers Using an Electronic Mail Interface

(76) Inventor: Roland Chemtob, New York, NY (US)

Correspondence Address: FENWICK & WEST LLP, SILICON VALLEY CENTER, 801 CALIFORNIA STREET, MOUNTAIN VIEW, CA, 94041, US

(21) Appl. No.: 12/058,305

(22) Filed: Mar. 28, 2008

Related U.S. Application Data
(60) Provisional application No. 60/909,070, filed on Mar. 30, 2007.

(51) Int. Cl. G06Q 40/00; G06Q 20/00

(52) U.S. Cl. 705/35

(57) ABSTRACT

A system and a method are disclosed for using an electronic mail (e-mail) interface to initiate and configure an electronic fund transfer. A fund transfer module is operatively interfaced with an e-mail module, allowing the fund transfer module and e-mail module to communicate data between each other. Responsive to the e-mail module receiving a generation input, data describing a fund transfer is received. The generation input can be s a user request or a receive e-mail including a request for payment. A representation of the fund transfer is generated from the received data and displayed by the e-mail module. For example, the fund transfer is displayed in a format replicating the appearance of a paper check. Responsive to the e-mail module receiving a user confirmation input that the representation of the fund transfer is accurate, an electronic transfer packet including the data describing the fund transfer is generated.

### CROSS REFERENCE TO RELATED APPLICATIONS

This application claims the benefit of U.S. Provisional Application No. 60/909,070, titled “Electronic Fund Transfers Using an E-Mail Interface” and filed Mar. 30, 2007, which is incorporated by reference in its entirety.

### BACKGROUND

1. Field of Art

The present invention generally relates to the field of monetary fund transfers, and more specifically, to electronically transferring monetary funds using an electronic mail (e-mail) interface.

2. Description of the Related Art

Online financial management is becoming increasingly common. Conventional methods allow a user to electronically pay bills or allocate assets between financial accounts using Internet resources. Hence, in addition to purchasing merchandise online, Internet users have a great degree of control over their assets using merely a computing device, such as a laptop computer, desktop computer, smartphone or similar device. This online financial management is simpler and faster than physically visiting a financial institution, such as a bank, and allows transactions to be completed faster than if existing paper-based methods, such as checks, were used to transfer funds.

Although online asset management and payment methods are increasingly more common, users must often use different interfaces to perform different types of transactions or to interact with different entities. For example, paying a telephone bill and a credit card bill online requires use of disparate interfaces associated with each entity. This user of multiple interfaces to interact with different entities or perform different actions is often cumbersome and confusing to inexperienced computer users and increases the time needed to complete each transaction. Because of this, many people still user paper checks, or other paper methods to pay bills or perform other financial activities because of the simplicity and familiarity of the paper methods.

Additionally, conventional electronic financial management techniques frequently require that a user access multiple websites to perform different actions. Hence, conventional online asset management often requires users to acclimate to various interfaces and to navigate between various websites, making some users reluctant to electronically make payments or manage their assets.

### SUMMARY

One embodiment of a disclosed system and method uses an electronic mail (e-mail) interface to initiate and configure an electronic fund transfer. In an embodiment, a fund transfer module is operatively interfaced with an e-mail module, allowing the fund transfer module and e-mail module to communicate data between each other. For example, the fund transfer module comprises a plug-in program that operates in conjunction with the e-mail module. Responsive to the e-mail module receiving a generation input, data is received that describes a fund transfer. In one embodiment, the generation input comprises a user request to initiate an electronic fund transfer. In another embodiment, the generation input is a received e-mail that includes a request for payment, such as an invoice. The received data describing the fund transfer is used to generate a representation of the fund transfer that is displayed by the e-mail module. In one embodiment, the representation of the fund transfer is displayed in a format that replicates the appearance of a paper check. Responsive to the e-mail module receiving a user confirmation input that the representation of the fund transfer is accurate, an electronic transfer packet is generated. The electronic transfer packet includes the data describing the fund transfer, such as amount to be transferred, location of the funds to be transferred and party to receive the funds.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

The disclosed embodiments have other advantages and features which will be more readily apparent from the following detailed description and the appended claims, when taken in conjunction with the accompanying drawings, in which:

FIG. 1 is a block diagram of an electronic fund transfer system according to one embodiment of the invention.

FIG. 2 is a block diagram of a client according to one embodiment of the invention.

FIG. 3 is a block diagram of a fund transfer server according to one embodiment of the invention.

FIG. 4 is a flow chart of a method for implementing an electronic fund transfer using an e-mail interface responsive to user input according to one embodiment of the invention.

FIG. 5 is a flow chart of a method for automatically implementing an electronic fund transfer using an e-mail interface responsive to received data according to one embodiment of the invention.

FIG. 6 is an example e-mail interface for electronic fund transfer according to an embodiment of the invention.

### DETAILED DESCRIPTION

A system and method for using an e-mail interface to configure and execute an electronic fund transfer, such as by generating an electronic representation of a check for completion by a user and transmission via e-mail, are described. For purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure or characteristic described in connection with the embodiment is included in at least one embodiment of the invention. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the invention. This is done merely for convenience and to give a general sense of the invention. This description should be read to include one or at least one and the singular also includes the plural unless it is obvious that it is meant otherwise.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will be apparent from the description below. In addition, the present invention is not described with reference to any particular programming language. It will be appreciated that a variety of programming languages may be used to implement the teachings of the invention as described herein.

### Architectural Overview

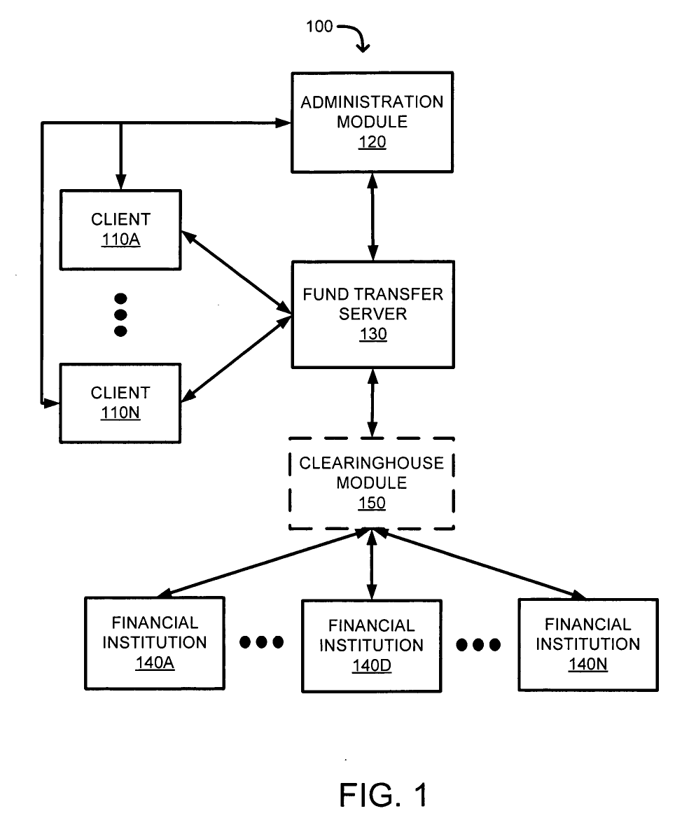

FIG. 1 shows a block diagram of a system 100 for electronic fund transfers according to one embodiment of the invention. The system 100 comprises one or more clients 110A-110N, an administration module 120, a fund transfer server 130 and one or more financial institutions 140A, 140D, 140N. In an embodiment, the system 100 also includes a clearinghouse module 150. A network (shown as various connecting lines between the above-described components) couples the various components to each other. Those of skill in the art will recognize that different embodiments can provide the functionality of FIG. 1 in different ways. Moreover, other embodiments can include different and/or additional features and/or components than the ones described here.

Clients 110A-N comprise computing devices with data communication and data processing capabilities, such as, for example, laptop computers, desktop computers, portable digital assistants, or smartphones. Clients 110A-N can be used by merchants and/or customers, allowing users of different clients 110A, 110N to exchange of goods and/or services for monetary compensation. In an embodiment, clients 110A-N transmit and receive electronic data, such as e-mails or data packets, between each other or between a client 110 and the administration module 120 and/or the fund transfer server 130. Transmissions between clients 110A-N and the fund transfer server 130 include financial data, such as financial account information, withdrawal amount, deposit amount, payment destination, a user identifier or other data associated with execution of a financial transaction. In an embodiment, transmissions between clients 110A-N and the administration module 120 comprise configuration data, such as username, password, billing address, contact information, financial account data, user preferences or other data associated with maintaining an account for electronically transferring funds.

The administration module 120 also comprises a computing device having data processing and data communication capabilities. The administration module 120 stores data associated with one or more accounts including user data and financial data. For example, the administration module 120 stores data including a username, a password, a user address, one or more financial account identifiers (e.g., checking account number, savings account number, money market account number, brokerage account number or any other identifier indicating an account for withdrawing or receiving monetary funds), user preferences (e.g., frequency of updates, data organization, display format, e-mail preferences or similar data describing presentation and storage of data) or other data associated with a user account. The administration module 120 also receives input from the clients 110 and the fund transfer server 130 and modifies one or more accounts responsive to the received data. This allows a user to remotely create and modify an account for electronically transferring funds from a client 110 while the account is maintained by the administration module 120. This centralized account management allows the account to be accessed and/or modified from multiple clients 110A-N, simplifying electronic transfer of funds by allowing a user to access the account used for fund transfers from multiple locations.

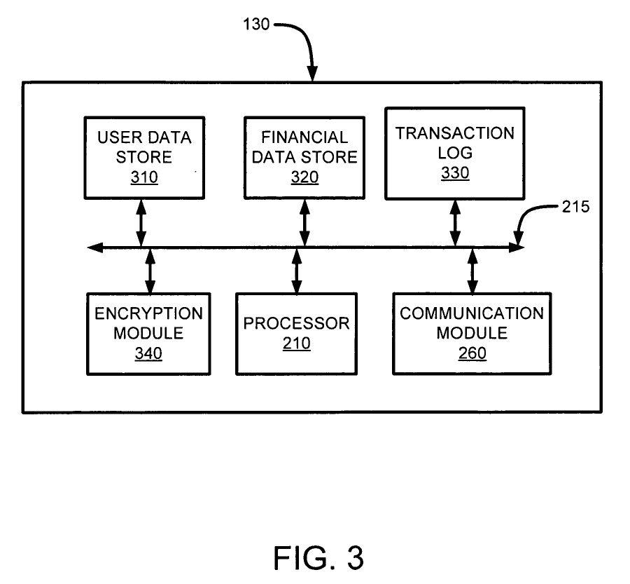

The fund transfer server 130 receives input from one or more clients 110A-N and/or the administration module 120. In one embodiment, responsive to input from clients 110A-N or the administration module 120, the fund transfer server 130 communicates with one or more financial institutions 140A, 140D, 140N, such as one or more banks or brokerage houses. Alternatively, the fund transfer server 130 is coupled to a clearinghouse module 150 which receives data describing credit and debit transfers for crediting or debiting accounts from the fund transfer server 130. Hence, the fund transfer server 130 communicates with the financial institution 140 or the clearinghouse module 150 to identify an account associated with data from a client 110 and to provide other information associated with the fund transfer, such as amount to transfer, transfer destination or other data used by the financial institution 140 or clearinghouse module 150 to complete the transfer. In an embodiment, the fund transfer server 130 also generates and stores a log of the transfers performed by different users including the destination of a transfer, the transferred amount, the financial account used for the transfer and/or other data describing a transaction to generate a user-specific transaction history. Additionally, the fund transfer server 130 encrypts data communicated to the financial institution 140 or clearinghouse module 150 to prevent unauthorized access to user account information. The fund transfer server 130 is described below in more detail with reference to FIG. 3.

In an embodiment, the system 110 also includes a clearinghouse module 150 which is coupled to the fund transfer server 130 and one or more financial institutions 140A-N. The clearinghouse module 150 comprises a computing device which receives debit and credit information from the fund transfer server 130 then processes financial transactions by crediting a receiving account and debiting a paying amount by the amount specified by the fund transfer server 130 and communicating the financial account modifications to a financial institution 140. The clearinghouse module 150 simplifies connection to multiple financial institutions 140A-N by reformatting data from the fund transfer server 130 into a format used by a financial institution 140, allowing the fund transfer server 130 to transfer data in a common format rather than identifying and separately formatting data for different financial institutions 140A-N.

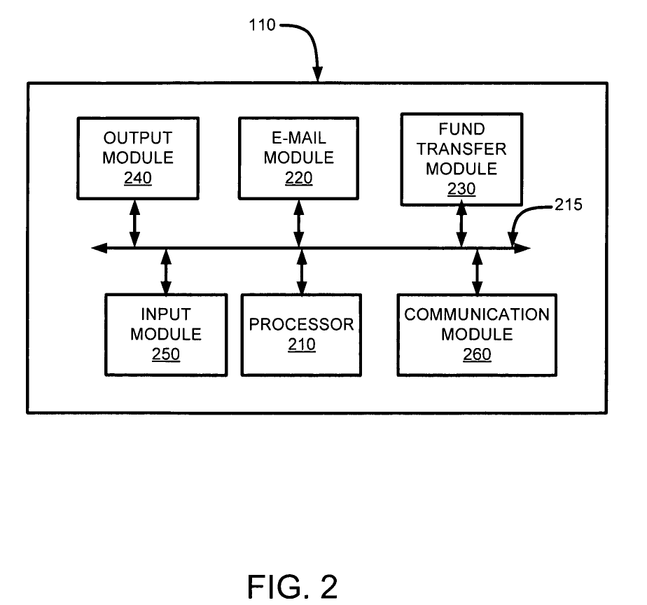

FIG. 2 is a block diagram of one embodiment of the present invention showing a client 110 in more detail. The client 110 comprises a processor 210, an electronic mail (e-mail) module 220, a fund transfer module 230, an output module 240, an input module 250 and a communication module 260 coupled by a bus 215. Those of skill in the art will recognize that different embodiments can provide the functionality of FIG. 2 in different ways. Moreover, other embodiments can include different and/or additional features and/or components than the ones described here.

The processor 210 processes data signals and may comprise various computing architectures including a complex instruction set computer (CISC) architecture, a reduced instruction set (RISC) architecture or an architecture implementing a combination of instruction sets. Although only a single processor is shown in FIG. 2, multiple processors may be included. The processor 210 comprises an arithmetic logic unit, a microprocessor, a general purpose computer, or some other information appliance equipped to transmit, receive and process electronic data from the e-mail module 220, the fund transfer module 230, the input module 250, the communication module 260 or other components of the client 110 and to transmit data to the output module 240 or other component of the client 110.

The e-mail module 220 receives e-mail and/or other data from the communication module 260 and displays the received e-mail or data to a user via output module 240. Additionally, the e-mail module 220 receives input from the input module 250 and generates an e-mail or modifies a stored e-mail responsive to the received input. Generated e-mail is then communicated to the communication module 260 for transmission to one or more recipients. In an embodiment, the e-mail module 220 also applies one or more filtering criteria to sort received e-mails and/or categorize e-mail based on input from the input module 250 that is communicated to the e-mail module 220.

The fund transfer module 230 is adapted to communicate with the e-mail module 220, the communication module 260, the output module 240, the input module 250 and/or other devices or modules. By communicating with the e-mail module 220, the fund transfer module 230 allows creation, modification and execution of a fund transfer using an interface similar to that used to view and edit e-mails. In an embodiment, the fund transfer module 230 is operatively interfaced with the e-mail module 220, allowing the fund transfer module 230 and e-mail module 220 to communicate data between each other, share functionality between each other and allow both the e-mail module 220 and the fund transfer module to use a shared data display. For example, the fund transfer module 230 displays a visual representation of a fund transfer within the display generated by the e-mail module 220, enabling the e-mail module 220 to display both e-mails and electronic representations of fund transfers using the output device 240 and to receive data for modifying e-mail and electronic fund transfers from the input device 250. Responsive to user input to the e-mail module 220, the fund transfer module 230 modifies the electronic fund transfer and the electronic representation of the fund transfer. Hence, the fund transfer module 230 and the e-mail module 220 work in conjunction with each other to generate and to transmit an electronic fund transfer from a client 110 to the fund transfer server 130. For example, after receiving data describing an electronic fund transfer from the e-mail module 220, the fund transfer module 230 generates an electronic transfer packet for transmission to the fund transfer server 130 using the e-mail transmission capabilities of the e-mail module 220 and communication module 260. For example, the electronic transfer packet describes the amount to be transferred, the recipient of the transfer, the account including the transferred funds, the date on which the transfer is to occur or other data associated with the fund transfer. Hence, the fund transfer module 230 allows an electronic fund transfer to be communicated to the fund transfer server 130 using e-mail or using a method similar to e-mail transmission. Hence, the fund transfer module 220 simplifies creation and execution of an electronic fund transfer by allowing use of the e-mail module 220 for receiving user input and communicating the electronic fund transfer to the fund transfer server 130. As users are typically more familiar with the interface used for managing e-mail, the relationship between e-mail module 220 and fund transfer module 210 allows use a similar interface for electronic fund transfer and e-mail management, simplifying generation and execution of electronic fund transfers.

In an embodiment, the fund transfer module 230 also examines e-mail or other data received by the e-mail module 220 from the communication module 260. For example, the fund transfer module 230 examines e-mail or e-mail attachments received by the communication module 260 to determine if the e-mail or e-mail attachment includes a request for payment or invoice. In an embodiment, the fund transfer module 230 compares data from an e-mail or e-mail attachment to one or more identifiers associated with invoices or request for payment. Responsive to determining that an e-mail or e-mail attachment includes a request for payment, the fund transfer module 230 extracts information from the e-mail or e-mail attachment, such as information describing the payment amount or payment recipient, and uses the extracted information to automatically generate an electronic transfer packet including the extracted information. This allows the fund transfer module 230 to automatically prepare an electronic transfer packet to execute a fund transfer responsive to a user receiving an invoice or other request for payment via e-mail.

The e-mail module 220 and the fund transfer module 230 can be implemented in many ways. For example, they can be one or more software processes executable by processor 210 and/or a firmware application. The software and/or firmware can be configured to operate on a general purpose microprocessor or controller, a field programmable gate array (FPGA), an application specific integrated circuit (ASIC) or a combination thereof. Alternatively, the e-mail module 220 and the fund transfer module 230 comprise one or more processors configured to process data signals and may comprise various computing architectures including a complex instruction set computer (CISC) architecture, a reduced instruction set computer (RISC) architecture, or an architecture implementing a combination of instruction sets.

For purposes of illustration, FIG. 2 shows the e-mail module 220 and the fund transfer module 230 as discrete modules. However, in various embodiments, the e-mail module 220 and the fund transfer module 230 can be combined in any number of ways. For example, the fund transfer module 230 comprises a plug-in which interacts with the e-mail module 220 to provide functionality for generating and modifying an electronic fund transfer. This allows the fund transfer module 230 to use the user interface of the e-mail module 220. This allows a single module to perform the functions of one or more of the above-described modules.

The output module 240 represents any device equipped to display electronic images and data as described herein. Output device 230 may be, for example, a light emitting diode (LED) display, liquid crystal display (LCD), cathode ray tube (CRT) display, or any other similarly equipped display device, screen or monitor. In one embodiment, output module 240 is equipped with a touch screen in which a touch-sensitive, transparent panel covers the screen of output module 240. The output module 240 displays data received from the processor 210, the e-mail module 220, the fund transfer module 230, the input module 250, the communication module 260 or other components of the client 110.

The input module 250 is any device configured to provide user input to the client 110 such as a cursor controller or a keyboard. In one embodiment, the input module 250 comprises an alphanumeric device, such as a QWERTY keyboard, a key pad or representations of such created on a touch screen, adapted to communicate information and/or commands to the processor 210, the e-mail module 220, the fund transfer module 230, the output module 240, the communication module 260 or other components. In another embodiment, the input module 250 is a user input device equipped to communicate positional data as well as command selections to the processor 210 such as a joystick, a mouse, a trackball, a stylus, a pen, a touch screen, cursor direction keys or other mechanisms to cause movement adjustment of an image.

The client 110 further comprises a communication module 260 enabling the client 110 to communicate with the administration module 120, the fund transfer server 130, additional clients 110 and/or other devices. In an embodiment, the communication module 260 comprises a transceiver such as for infrared communication, Bluetooth communication, 3 G communication, radio frequency communication, or any other wireless communication technique. In an alternative embodiment, the communication module 260 comprises a conventional wired connection, such as Ethernet, Universal Serial Bus (USB), or other wired communication techniques. Alternatively, the communication module 260 comprises both a wired connection and a transceiver. The communication module 260 allows data, commands and/or information to be distributed using network protocols, such as Transmission Control Protocol (TCP), Internet Protocol (IP), Hypertext Transmission Protocol (HTTP), or other protocols capable of communicating data or information.

FIG. 3 is a block diagram of one embodiment of the present invention showing the fund transfer server 130 in more detail. The fund transfer server 130 comprises a processor 210, a user data store 310, a financial data store 320, a transaction log 330, an encryption module 340 and a communication module 260 coupled by a bus 215. Those of skill in the art will recognize that different embodiments can provide the functionality of FIG. 3 in different ways. Moreover, other embodiments can include different and/or additional features and/or components than the ones described here.

The user data store 310 comprises a storage device including data describing one or more user accounts. For example, the user data store 310 includes data, such as a username, or other identifier, which uniquely identifies different users and associates one or more financial account identifiers with each username. In an embodiment, the user data store 310 also stores demographic data, such as name, address, telephone number, e-mail address or other data associated with a user. In an embodiment, the user data store 310 also includes data describing user preferences, such as e-mail module 220 characteristics, user-specific display settings, user-specific data storage parameters, user-specific update information or other data describing user operating parameters.

The financial data store 320 comprises a storage device including data describing one or more financial accounts. For example, the financial data store 320 includes a financial account identifier, a financial account number (e.g., a checking account number, a savings account number or other information used by a financial institution to identify an account), a financial institution associated with the financial account identifier and contact details for the financial institution (e.g., a bank address, phone number or other contact information). In an embodiment, the financial data store 320 includes additional data associated with a financial account, such as the current account balance or a limit on the amount of funds that can be withdrawn from the account. Hence, the financial account identifier associates user information from the user data store 310 with financial account data in the financial data store 320. Further, the financial account information and financial institution data stored in the financial data store 320 allow data from the fund transfer server 130 to be used by a financial institution 140 or clearinghouse module 150 for withdrawing and/or depositing money into an identified account.

The transaction log 330 comprises a storage device including transaction records describing completed or pending transactions. In an embodiment, the stored transaction records include a description of various transactions, such as the date on which the transaction occurred, the account used for the transaction, the amount transacted, the recipient of the transaction, the current status of the financial transaction (e.g., completed, pending, rejected or another suitable status identifier) or other data describing the transaction. In another embodiment, the transaction log 330 also organizes transaction records based on one or more preferences stored in the user data store 310, simplifying subsequent transaction access or analysis. For example, the transaction log 330 stores transaction records according to the date on which the transaction occurred or according to the account used for the financial transaction, facilitating subsequent review of transactions by date or by account.

In various embodiments, the user data store 310, the financial data store 320 and the transaction log 330 comprise one or more storage devices. The one or more storage devices comprise a hard disk drive, a flash memory device or other suitable persistent storage device. Further, the storage device or storage devices can be a volatile storage device (e.g., dynamic random access memory (DRAM), static random access memory (SRAM) or another suitable memory device), a non-volatile storage device or a combination of a non-volatile storage device and a volatile storage device. In another embodiment, a single storage device is divided into multiple partitions for the user data store 310, the financial data store 320 and the transaction log 330, allowing the single storage device to perform the functions of one or more of the user data store 310, the financial data store 320 and/or the transaction log 330.

The encryption module 340 communicates with the financial data store 320, the user data store 310 and the communication module 260. The encryption module 340 encrypts data from the user data store 310 and/or the financial data store 320 and transmits the encrypted data to the communication module 260 for transmission to another device. For example, the encryption module 340 applies an encryption method, such as a Data Encryption Standard (DES) cipher, an Advanced Encryption Standard (AES) cipher or other suitable encryption method, to data from the financial data store 320 and user data store 310. After encryption, the data is communicated to the communication module 260 for transmission to another device. By encrypting data before transmission from the fund transfer server 130, the encryption module 340 increases the security of an electronic fund. In an embodiment, the encryption module also encrypts data stored in the user data store 310, the financial data store 320 and/or the transaction log 330 to increase security of data locally stored by the fund transfer server 130.

The encryption module 340 can be implemented in many ways. For example, it can be one or more software processes executable by processor 210 and/or a firmware application. The software and/or firmware can be configured to operate on a general purpose microprocessor or controller, a field programmable gate array (FPGA), an application specific integrated circuit (ASIC) or a combination thereof. Alternatively, the encryption module 340 comprises one or more processors configured to process data signals and may comprise various computing architectures including a complex instruction set computer (CISC) architecture, a reduced instruction set computer (RISC) architecture, or an architecture implementing a combination of instruction sets.

The communication module 260, as described above in conjunction with FIG. 2, communicates data between the fund transfer server 130, the clearinghouse module 150, the administration module 120 and one or more clients 111A-N. Similarly, the processor 210, as described above in conjunction with FIG. 2, receives and processes data from the encryption module 340, the user data store, 310, the financial data store 320, the transaction log 330, the communication module or other components of the fund transfer server 130.

### System Operation

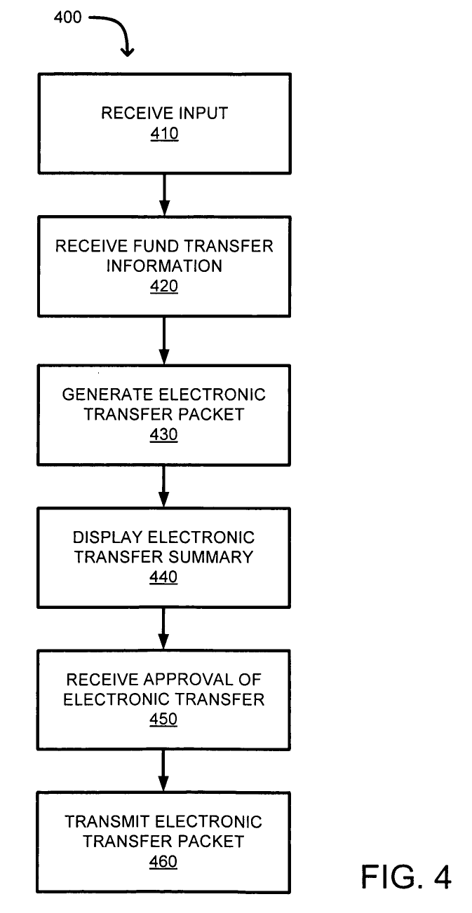

FIG. 4 is a flow chart of a method 400 for executing an electronic fund transfer responsive to a user command according to one embodiment of the invention. Those of skill in the art will recognize that other embodiments can perform the steps of FIG. 4 in different orders or include different and/or additional steps than the ones described herein.

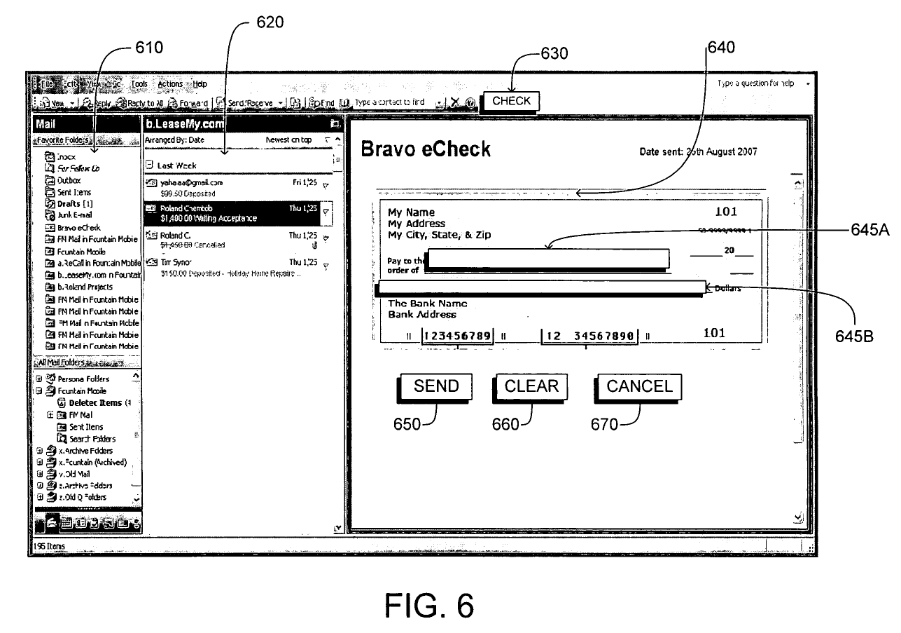

Initially, user input to begin an electronic fund transfer is received 410 by the e-mail module 220 or the fund transfer module 230. For example, a user selects a menu item, button or icon generated by the e-mail module 210 and displayed by the output module 240 which prompts the user for data associated with the electronic fund transfer. The e-mail module 210 then receives 420 data from the user describing the electronic fund transfer. For example, the e-mail module 210 displays, via output module 240, a button associated with electronic fund transfers along with user e-mail. Responsive to the user selecting the button by interacting with the input module 250, the e-mail module 210 requests data associated with the electronic fund transfer from the user. An example user interface for receiving 410 input to initiate an electronic fund transfer and for receiving 420 user information describing the electronic fund transfer is described below in conjunction with FIG. 6.

For example, the e-mail module 210 receives 420 data describing the amount to be transferred, the recipient of the amount transferred, the financial account including the funds to be transferred, the date of the transfer, user comments or other data associated with the electronic fund transfer. The received data is communicated from the e-mail module 210 to the fund transfer module 220 which generates 430 an electronic transfer packet including the data necessary for executing an electronic fund transfer in a format readable by the fund transfer server 130. Hence, the fund transfer module 230 modifies the received fund transfer data into a format used by the fund transfer server 130.

A summary of the electronic fund transfer is then displayed 440 to the user via e-mail module 210 and output module 240 for verification. This allows the user to review the fund transfer information and to modify the fund transfer data if necessary before the fund transfer is initiated. In one embodiment, the summary of the electronic fund transfer is displayed 440 in a visual format similar to a paper check, as shown in FIG. 6. Displaying in a format similar to a paper check allows a user to view the summary in a format in a familiar format, expediting user review. Alternatively, the electronic fund transfer summary is displayed 440 as a web page, text document, spreadsheet, table or any other format including data associated with the electronic fund transfer.

If, after reviewing the electronic fund transfer summary, the user determines that the data describing the electronic fund transfer is accurate, the e-mail module 210 receives 450 approval of the electronic fund transfer, and the generated electronic fund transfer packet is transmitted 460 to the fund transfer server 130, via communication module 260, which extracts data from the electronic fund transfer packet identifying the user account, financial institution and fund recipient. For example, the displayed electronic fund transfer summary includes a button, image, hyperlink or other user-selectable region that, when selected, indicates user approval of the electronic fund transfer, causing transmission 460 of the electronic fund transfer packet. The data extracted from the electronic transfer packet is then communicated from the fund transfer server 130 to the clearinghouse module 150 or financial institution 140 to complete the electronic fund transfer.

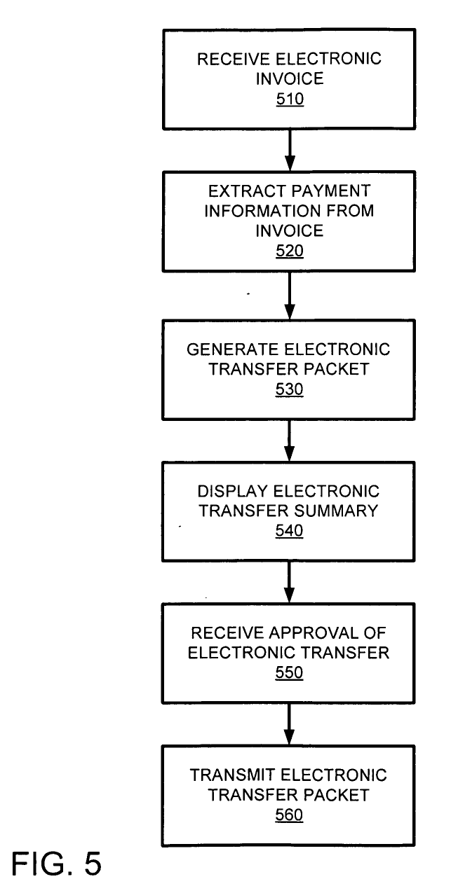

FIG. 5 is a flow chart of a method 500 for automatically implementing an electronic fund transfer using an e-mail interface responsive to received data according to one embodiment of the invention. In an embodiment, the e-mail module 220 receives 510 an electronic invoice and uses the electronic invoice to automatically generate an electronic fund transfer packet configured to pay the amount indicated by the electronic invoice. For example, the e-mail module 210 receives an e-mail or e-mail attachment, such as a portable document format (PDF) file, which includes metadata or data identifying the e-mail or e-mail attachment as an invoice. The electronic invoice includes one or more data fields that specify the amount to be paid, the payee and other information used in an electronic fund transfer.

After receiving 510 the electronic invoice, the fund transfer module 230 extracts 520 payment information from the electronic invoice. For example, the fund transfer module 230 extracts 520 data describing the payment amount and the party to receive the funds. In an embodiment, the electronic invoice comprises multiple fields, allowing the fund transfer module 230 to identify payment information by examining one or more fields. Alternatively, the electronic invoice associates identification tags with data, so that examination of the tags allows the fund transfer module to identify payment information.

The extracted data is then used by the fund transfer module 230 to generate 530 an electronic transfer packet including the data necessary for executing an electronic fund transfer in a format readable by the fund transfer server 130. Hence, the fund transfer module 230 modifies the received fund transfer data into a format used by the fund transfer server 130.

A summary of the electronic fund transfer is then displayed 540 to the user via e-mail module 210 and output module 240 for verification. This allows the user to review the fund transfer information and to modify the fund transfer data if necessary before the fund transfer is initiated. In one embodiment, the summary of the electronic fund transfer is displayed 540 in a visual format similar to a paper check, as shown in FIG. 6. Displaying in a format similar to a paper check allows a user to view the summary in a format in a familiar format, expediting user review. Alternatively, the electronic fund transfer summary is displayed 540 as a web page, text document, spreadsheet, table or any other format including data associated with the electronic fund transfer.

If, after reviewing the electronic fund transfer summary, the user determines that the data describing the electronic fund transfer is accurate, the e-mail module 210 receives 550 approval of the electronic fund transfer, and the generated electronic fund transfer packet is transmitted 460 to the fund transfer server 130, via communication module 260, which extracts data from the electronic fund transfer packet identifying the user account, financial institution and fund recipient. For example, the displayed electronic fund transfer summary includes a button, image, hyperlink or other user-selectable region that, when selected, indicates user approval of the electronic fund transfer, causing transmission 460 of the electronic fund transfer packet. The data extracted from the electronic transfer packet is then communicated from the fund transfer server 130 to the clearinghouse module 150 or financial institution 140 to complete the electronic fund transfer.

In an embodiment, the steps of methods 400, 500 are implemented by the processor 210 executing a computer program causing the described actions. Those of skill in the art will recognize that one or more of the methods may be implemented in embodiments of hardware and/or software or combinations thereof. For example, instructions for performing the described actions are embodied or stored within a computer readable storage medium.

### User Interface

FIG. 6 is an example e-mail interface for electronic fund transfer according to an embodiment of the invention. Those of skill in the art will recognize that different embodiments can provide the information and functionality of FIG. 6 in different ways. Moreover, other embodiments can include different and/or additional features and/or layouts than the ones described here. In this embodiment, the user interface is a plug-in which acts in conjunction with an e-mail client to allow a user to identify and begin a fund transfer from within the e-mail client.

As shown in FIG. 6, the e-mail interface includes a folder listing 610 describing various folders that include e-mails or other data. A content region 620 is associated with the folder listing 610 and displays information describing the contents of a selected folder. For example, the content region 620 displays data, such as subject, sender, transmission or receipt date, associated with various e-mails or other data included in a selected folder. This allows the content region 620 to provide an overview of the data stored in a folder selected from the folder listing 610.

A transfer preparation region 630 receives input from a user to initiate an electronic fund transfer. As shown in FIG. 6, the fund preparation region 630 comprises a user selectable button. However, this is merely an example and in other embodiments the transfer preparation region 630 comprises a hyperlink, an image or any other mechanism capable of receiving user input.

After the transfer preparation region 630 receives user input to initiate an electronic fund transfer, a transfer configuration region 640 is displayed to the user. As shown in FIG. 6, the transfer configuration region 640 is displayed in a format that resembles a conventional check. For example, the fund configuration region 640 includes the payer's name and address, a numerical identifier, the name of the financial institution including the funds to be transferred, the address of the financial institution including the funds to be transferred and/or additional data associated with the electronic fund transfer. However, displaying the transfer preparation region 630 as visually similar to a paper check is merely an example and in other embodiments, the transfer preparation region 630 is displayed as a web page, a spreadsheet, a form or other suitable format.

The transfer preparation region 630 includes one or more data entry regions 645. The data entry regions 645 receive input from a user corresponding to different aspects of the fund transfer. Although shown in FIG. 6 as displayed adjacent to the content region 620, in other embodiments the transfer preparation region 630 comprises a separate window or a full-screen display. For example, a first data entry region 645A receives from the user an identification of the party to receive the transferred funds, such as a personal name or corporate name, while a second data entry region 645B receives from the user data describing the amount of funds involved in the transactions. In an embodiment, the fund transfer module 230 generates additional data from the data received by one or more of the data entry regions 645. For example, if the user enters a numerical payment amount, such as “$100,” in the second data entry region 645B, the fund transfer module 230 generates a different format of the data, such as a textual format, such as “One hundred dollars.” This allows a user to enter data in a simple format that is automatically converted to a format suitable for transmission to the fund transfer server 130, further simplifying configuration of an electronic fund transfer.

The transfer preparation region 630 also includes a confirmation region 650, a clear region 660 and a cancel region 670. The transfer preparation region 630 also includes a confirmation region 650, a clear region 660 and a cancel region 670 receives user input. In various embodiments, the confirmation region 650, the clear region 660 and/or the cancel region 670 comprise a button, a hyperlink, an image or any other mechanism or combination of mechanisms capable of receiving user input.

Responsive to user selection of the confirmation region 650, the electronic transfer packet associated with the electronic fund transfer is transmitted to the fund transfer server 130. Hence, selection of the confirmation region 650 indicates that the electronic fund transfer is to proceed using the data included in the transfer preparation region 630. Conversely, user selection of the cancel region 670 indicates that the electronic fund transfer is not to proceed, and selection of the cancel region 670 deletes the data included in the transfer preparation region 630 and removes the transfer preparation region 630 from being displayed. Selection of the clear region 660 deletes the data included in the transfer preparation region 630 while maintaining display of the transfer preparation region 630, allowing the user to enter new data into the data entry regions 645. Hence, the clear region 660 allows the user to enter new electronic fund transfer data.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats. Furthermore, as will be apparent to one of ordinary skill in the relevant art, the modules, routines, features, attributes, methodologies and other aspects of the present invention can be implemented as software, hardware, firmware or any combination of the three. Of course, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

What is claimed is:

1. A computer-implemented method for electronically transferring funds comprising:
operatively interfacing a fund transfer module with an electronic mail (e-mail) module;
responsive to a generation input to the e-mail module, receiving data describing a fund transfer;
displaying a representation of the fund transfer from the received data describing the fund transfer using the e-mail module;
responsive to a user confirmation input to the e-mail module, generating an electronic transfer packet including the data describing the fund transfer.

2. The method of claim 1, further comprising:
transmitting the electronic transfer packet to a fund transfer server.

3. The method of claim 1, wherein the representation of the fund transfer comprises a graphical representation of a check showing the data describing the fund transfer.

4. The method of claim 1, wherein the data describing the fund transfer comprises a financial account number, a transfer amount, a transfer recipient and a transfer date.

5. The method of claim 1, wherein the generation input to the e-mail module comprises a user input.

6. The method of claim 1, wherein the generation input to the e-mail module comprises an e-mail including a request for payment.

7. The method of claim 1, wherein the generation input to the e-mail module comprises an e-mail attachment including a request for payment.

9. The method of claim 1, wherein the fund transfer module operatively interfaces with the e-mail module via a plug-in module.

10. A computer-readable storage medium storing a computer program executable by a processor, the computer program implementing a method for electronically transferring funds comprising:
operatively interfacing a fund transfer module with an electronic mail (e-mail) module;
responsive to a generation input to the e-mail module, receiving data describing a fund transfer;
displaying a representation of the fund transfer using the e-mail module;
responsive to a user confirmation input to the e-mail module, generating an electronic transfer packet including data describing the fund transfer.

11. The computer-readable storage medium of claim 10, wherein the method further comprises:
transmitting the electronic transfer packet to a fund transfer server.

12. The computer-readable storage medium of claim 8, wherein the representation of the fund transfer comprises a graphical representation of a check showing the data describing the fund transfer.

13. The computer-readable storage medium of claim 10, wherein the data describing the fund transfer comprises a financial account number, a transfer amount, a transfer recipient and a transfer date.

14. The computer-readable storage medium of claim 10, wherein the generation input to the e-mail module comprises a user input.

15. The computer-readable storage medium of claim 10, wherein the generation input to the e-mail module comprises an e-mail including a request for payment.

16. The computer-readable storage medium of claim 10, wherein the generation input to the e-mail module comprises an e-mail attachment including a request for payment.
